(19) United States
(12) Patent Application Publication
(10) Pub. No.: US 2006/0250033 A1
(43) Pub. Date: Nov. 9, 2006

(54) Rotating electrical machine comprising a ventilator

(76) Inventors: Claudiu Vasilescu, Paris (FR); Richard Tellier, Paris (FR)

Correspondence Address: Berenato White & Stavish, 6550 Rock Spring Drive, Suite 240, Bethesda, MD, 20817, US

(21) Appl. No.: 10/553,970

(22) PCT Filed: May 25, 2004
(86) PCT No.: PCT/FR04/01291

§ 371 Date: Oct. 19, 2005

(30) Foreign Application Priority Data
May 26, 2003 (FR) 03/06347

(51) Int. Cl. H02K 5/24; H02K 9/00; H02K 9/06

(52) U.S. Cl. 310/62; 310/58; 310/51

(57) ABSTRACT

The invention relates to a rotary electrical machine which comprises a stator and a rotor, the rotor having zones which are arranged for balancing operations to be performed on them, together with at least one fan which is adapted to be mounted on the rotor and which includes a radial plate portion (3) and fan blades, wherein the fan fixed on the rotor is pre-balanced. It also relates to a method of fitting this fan in the machine.

### FIELD OF THE INVENTION

This invention relates to a rotary electrical machine, of the alternator or alternator-starter type, in which the fan has the feature that it is balanced before being mounted on the rotor of the machine.

The invention is applicable in the field of the motor industry, and in particular in the field of alternators and alternator-starters for motor vehicles.

### CURRENT STATE OF THE ART

In a motor vehicle, the alternator converts rotary movement of the inductor rotor, which is driven by the engine of the vehicle, into an electrical current which is induced in the winding of the stator. The alternator can also be reversible. It therefore constitutes an electric motor which drives the heat engine of the vehicle in rotation via the shaft of the rotor. This reversible alternator is called an alternator-starter.

In a rotary electrical machine, whether it consists of an alternator or an alternator-starter, some elements such as the electronic control circuit, the rectifier bridge and the windings of the stator and rotor, generate heat. It is therefore imperative to cool the machine. This is generally done by means of a fan arrangement which includes at least one fan fitted inside the machine. Some machines have only one fan, generally located to the rear of the rotor, that is to say on the same side as the rectifier bridge in the case of an alternator. Other machines have two fans, which are located in front of the rotor and behind it, respectively.

One example of an alternator with two fans is shown in FIG. 1.

This alternator comprises a motion transmitting member 1, which is called a pulley and which is part of a motion transmitting device not shown in FIG. 1, which is interposed operatively between the engine of the vehicle and the alternator. Extending partly through this member 1 is a rotatable shaft 2, with which the member 1 is coupled for rotation with it, the axial axis of symmetry XX of the shaft being the axis of rotation of the machine. The rotatable shaft 2 carries a rotor 4, for example a claw-type rotor, which is provided with at least one excitation winding. The rotor 4 is surrounded by a wound stator 5 which includes one or more coils that constitute the armature winding. The stator 5 is carried by a front bearing plate 8 and a rear bearing plate 6, both of which include, at the axial ends, a ball bearing which carries the rotatable shaft 2.

In the example shown in FIG. 1, the alternator has two fans, namely a fan 9 at the front of the rotor and a fan 7 behind it, both of which being fixed to the rotor. Another example of an alternator could have only one fan, which would generally be the rear fan 7, which is more powerful than the front fan 9 located on the same side as the drive pulley 1.

Such a fan comprises a radial plate portion 3, from which a set of projecting blades 8a, 7a extend. It is fixed generally on the rotor by welding of the plate on the rotor. Now, because of the fact that it is fabricated, a fan is generally asymmetrical to start with. In other words, if it is desired that a fan be caused to rotate at its point of rotation, it can be seen that it is not naturally balanced. In addition, the rotor is no longer balanced to start with. In consequence, the fact that an unbalanced fan is fitted on an unbalanced rotor sets up a degree of imbalance in the rotor and fan assembly when this assembly is set in motion. This imbalance gives rise to eccentricity during rotation of the rotor, which results in significant bending of the shaft and radial vibrations of the rotor, which in turn can bring it into mechanical contact with the inner periphery of the stator.

In order to eliminate this imbalance, a person familiar with this technical field will normally carry out a balancing operation on the assembly before it is set in motion. This balancing operation is achieved generally by modifying the mass of the assembly in such a way that its centre of gravity is changed. This change, by modification of the mass, is achieved by removing material from the rotor by means of drill bits which make holes 25 in a pierced zone 26 located in the base portion 27 of at least one claw 45 of the rotor 4, as can be seen in FIG. 1. The base portion 27 of the claw joins the claw to the radial plate portion 29 of the pole wheel 43, which lies at right angles to the axis XX. Now, the drill bits used are relatively heavy ones. Accordingly, they make it necessary to provide a relatively wide passage across the blades of the fan, that is to say between two consecutive blades of the fan. It is therefore necessary, in order to enable the drill bits to pass through, that there be a minimum space 26 between two consecutive blades, and a minimum angle between these two blades.

The drill bits have positions which are well defined with respect to the claws of the rotor. The zones 26 accessible to these drill bits subtend an angle of about 20°, and in consequence the blades must be kept out of these zones. For example, if the rotor has eight pairs of poles, then a zone of 160° has to be free of the blades of the fan.

The result of this is that the possible number of blades in the fan is limited. This also has the consequence that the possible forms for the blades of the fan are limited, as for example in the blade 30 in FIG. 2, which has had to be shortened to enable the drill bit to pass through. The shortening of the blades has a negative influence on the air flow. In addition, shortening of the blades increases the imbalance, thereby giving rise to a vicious circle. For the same reasons, some of the blades 31 are cantilevered, which is detrimental to the mechanical strength of the fan when the rotor is turning at very high speeds.

The balancing of this rotor and fan assembly therefore involves constraints as to the form of the fan.

In addition, the said drill bits are designed to drill in metallic materials. The bits are not capable of drilling workpieces of plastics materials without running the risk of breaking or damaging the workpieces, as in the case of fans made of plastics materials. Thus in general terms, the metallic or plastics fan, with or without a metallic insert, has to be designed in such a way that it does not interfere with the zones reserved for access of drilling tools. The consequence of this is that it is not possible to achieve the maximum optimisation of the fan in terms of output, noise or size.

The operation of balancing the sub-assembly consisting of the rotor and fan is a precision operation that requires a time of execution which is not insignificant, and which is even longer as the imbalance to be corrected is larger.

### DISCUSSION OF THE INVENTION

In precise terms, the object of the invention is to overcome the disadvantages of the techniques described above, and the invention proposes a rotary electrical machine comprising a stator and a rotor, the rotor including zones which are adapted for balancing operations thereon, together with at least one fan which is adapted to be mounted on the rotor and which includes a radial plate portion and fan blades, characterised in that the fan fixed on the rotor is pre-balanced.

In other words, the invention proposes a rotary electrical machine of the alternator type, in which the fan is fixed on the rotor after having been balanced beforehand. In this way, the inherent imbalance of the fan is nil, or very small if there are any errors in centring with respect to the axis of rotation of the machine during its fastening on the rotor. Since the imbalance to be corrected is greatly reduced due to the use of a pre-balanced fan, it is possible to envisage, right from the time of designing the machine, the use of balancing drills having a greatly reduced diameter, and this is all the more true if the rotor is itself already partly balanced. In the case where the rotor and the fan are perfectly balanced independently of each other, the absence of any zone at all dedicated to the drill bits on the rotor can even be envisaged, and this would enable a fan to be conceived which was perfectly optimised, and would also enable balancing time to be reduced, which could diminish to a simple control.

According to further features of the invention:

the radial plate portion of the fan has a non-constant thickness.

the radial plate portion of the fan includes portions of material of increased thickness and/or thinned zones.

the radial plate portion of the fan includes holes.

at least one blade includes additions of material for the purpose of balancing the fan.

at least one blade has a chamfer for the purpose of balancing the fan.

the fan is a fan consisting of two superimposed fans.

at least one of the two fans includes added elements or thinned portions, or has material removed, with a view to balancing it.

the radial plate portion of each of the two superimposed fans has holes or thinned portions in at least one common zone.

the radial plate portion of each of the two superimposed fans includes holes or thinned portions in different zones.

the rotor is pre-balanced.

a balancing hole of the rotor is in line with a blade of the pre-balanced fan.

the central bore of the fan is de-centred so as to bring the axis of rotation of the machine into coincidence with the centre of gravity of the fan.

the fan is fixed eccentrically on the rotor in order to bring the axis of rotation of the machine into coincidence with the centre of gravity of the fan.

The invention also provides a method of fitting a fan in a rotary electrical machine, characterised in that it includes operations of balancing the fan and then of fastening the balanced fan on the rotor.

### BRIEF DESCRIPTION OF THE DRAWINGS

FIG. 1, already described, shows a conventional alternator with a fan fixed on a rotor.

FIG. 2, already described, shows an axial view of a fan mounted on a rotor in the prior art.

FIG. 3 shows one example of a pre-balanced fan according to the invention.

FIG. 4 shows a further example of a pre-balanced fan according to the invention.

FIG. 5 shows another example of a pre-balanced fan according to the invention.

FIGS. 6a and 6b show further examples of pre-balanced fans according to the invention.

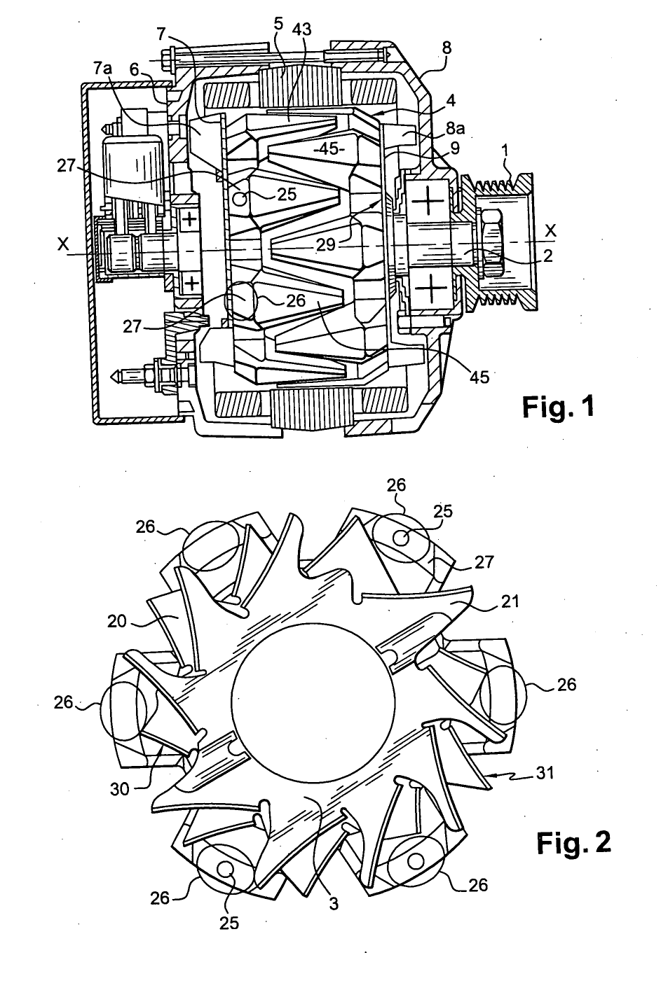

### DETAILED DESCRIPTION OF EMBODIMENTS OF THE INVENTION

The invention is concerned with a method of designing a fan for a rotary electrical machine, for example an alternator. This method proposes that the fan should be balanced before being fitted on the rotor of the machine.

In other words, the method of the invention consists in balancing a fan which is not naturally balanced, and then in mounting and fixing this fan on a machine rotor.

Preferably, the rotor can have been balanced beforehand on its rotating shaft. In order to perform the pre-balancing of the rotor, it is possible with advantage to make use of zones arranged to be eventually overlain by the blades of the pre-balanced fan.

If the rotor is not balanced before being fitted, the provision of emplacements for the balancing drills will be taken into account during design of the fan, but the size of these emplacements will be able to be considerably reduced, because the imbalance to be corrected will be reduced due to the use of a pre-balanced fan.

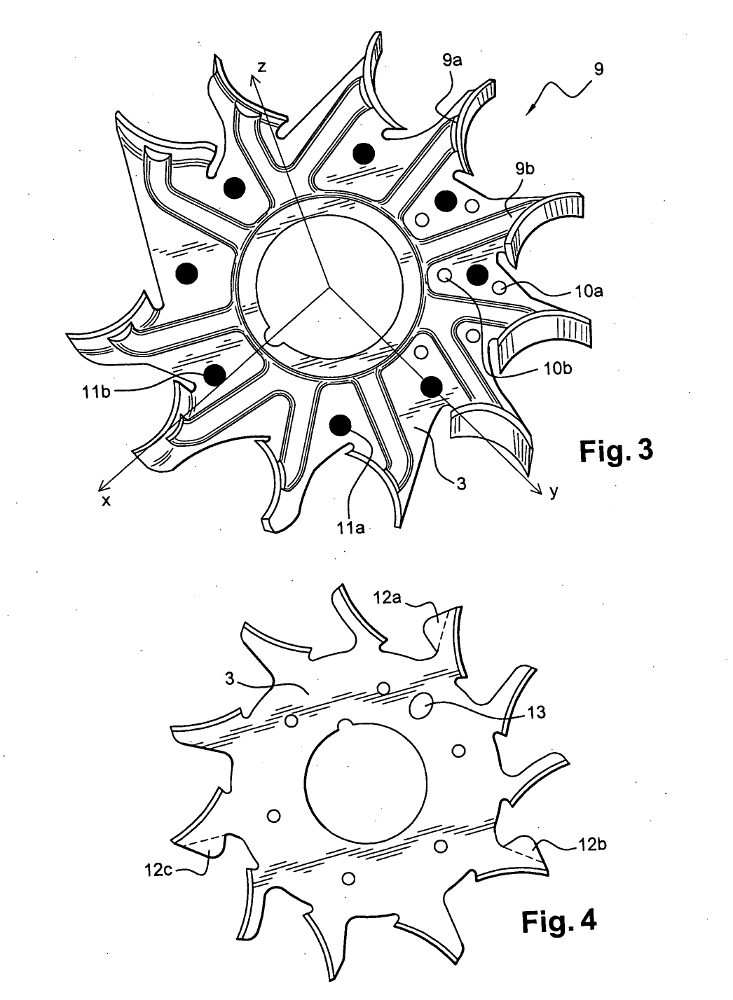

FIG. 3 shows one example of a pre-balanced fan, that is to say a fan which is balanced before being fitted on the rotor. This fan 9 comprises a radial plate portion 3 and a set of fan blades which project with respect to the plate portion. Two blades in this set of fan blades are given the reference numerals 9a and 9b. The fan is shown in FIG. 3 in a three-dimensional Cartesian co-ordinate frame XYZ in which the origin is the point O.

The balancing of the fan 9 is carried out by determining the centre of gravity of the fan within the frame XYZ. It is considered that the fan 9 is balanced when its centre of gravity is coincident with the point of origin O of the frame, if the point of origin is coincident with the axis of rotation. If the centre of gravity is not at the point of origin O, as defined above, then the fan is unbalanced.

Fans are generally unbalanced naturally, that is to say that because of their fabrication, they are not balanced so long as a balancing operation has not been carried out.

In the invention, it is sought to bring the centre of gravity of the fan to the point of origin O. For this purpose, the distribution of the mass of the fan is modified by adding or removing material in the fan. In practice, this modification of the distribution of mass is achieved by withdrawing material from within the fan, thereby creating thinned zones or even apertures, and/or by adding elements increasing the thickness of material on the material, or special forms in the pressing out of the blades. More precisely, the modification of the distribution of mass is performed on the plate portion of the fan. It can also be envisaged that removals or additions of material on the fan blades be carried out, for example by forming chamfers on the said blades.

The addition of material and removal of material are done using techniques known to the person familiar with this technical field, for example by varying the thickness of the material where the fan is moulded or made by in situ moulding of plastics material, or again by forming holes, or the addition of forms in the plate portion or in the blades. These modifications to the blades are easy to carry out, for example where they are in plastics material.

The choice of the quantity of material to be added and/or removed, and the replacement of these additions or removals of material, is done by a set of mechanical calculations made from the total form of the fan (that is to say its dimensions, number of blades, distribution of the blades, thicknesses, and so on).

After the balancing operation, the plate portion of the fan may have a thickness which is not constant, that is to say it is locally thicker, or on the other hand, thinner. It may also include apertures such as those with the reference numerals 10a and 10b in FIG. 3.

Balanced in this way, the fan can then be mounted and fixed on a rotor mounted on a rotatable shaft. This rotor has itself preferably been balanced before receiving the fan. It will easily be understood that the rotor is easier to balance when there is no fan mounted on it. In this connection there are no fan blades, nor any plate portion of plastics material, to hinder the passage of the drilling tools and the drilling of the metal. The rotor can therefore easily be balanced using drilling tools.

The mounting of the fan can be done in the usual ways. The fan can then be fixed on the rotor by known fastening methods. In the example shown in FIG. 3, it is arranged that the fan be fixed on the rotor by spot welds 11a, 11b.

FIG. 4 shows one example of the balancing of a fan made from metal plate by addition of material 12a, 12b, 12c on the blades and/or by removing material 13 from the plate portion of the fan.

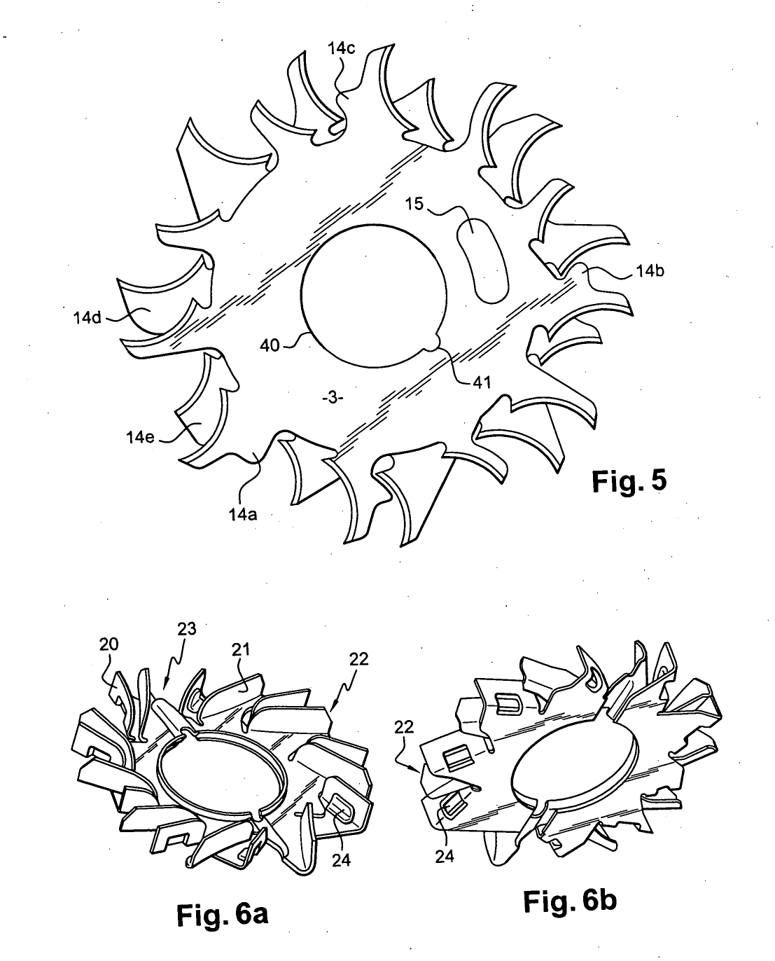

FIG. 5 shows the balancing of a double fan, which is made for example by superimposing two metal fans on each other. A double fan is described for example in the document FR 2 741 912. In accordance with the same principle constituting the invention, the balancing operation is carried out by adding material 14a, 14b, 14c, 14d, 14e to the blades of the lower fan 20 and/or to the blades of the upper fan 21, the lower fan being the one which is placed against the rotor of the electrical machine. In this case, material 15 is removed, for example in the form of a hole or a reduction in the thickness of the material, and this removal may be carried out on either one of the two fans or on both of them, and not necessarily in the same zone. Thus, if for example it is done by forming holes, they are not necessarily superimposed on each other.

FIGS. 6a and 6b show a further example of balancing, which is done by forming chamfers 22 on the blades of the lower and/or upper fan. These chamfers may clearly be formed on a simple fan. The wiring channel rib 23, and the ribs 24 which reinforce the mechanical strength of the blades may also be designed in such a way as to play a part in the balancing of the fan.

It is also preferably arranged that the pre-balanced fan according to the invention should be mounted in such a way that it is off centre with respect to the axis of rotation, whereby its centre of gravity is coincident with the axis of rotation of the rotor. This decentring enables errors, arising from manufacturing tolerances in the use of the tooling used for making the fan, to be corrected. The said decentring enables balancing of the fan on the rotor of the rotary electrical machine to be adjusted in the best possible way.

In a modified embodiment, it is also possible to envisage that the central bore 40 be decentred, as can be seen in FIG. 5, in such a way that the axis of rotation of the electrical machine coincides with the centre of gravity of the fan. The notch 41 enables the fan to be indexed circumferentially on the rotor, or in the case of a double superimposed fan, it allows the two fans to be indexed with respect to each other. The notch 41 can also contribute to the balancing of the fan by virtue of its position or its shape.

This method of mounting a balanced fan on a balanced rotor enables any kind of fan to be mounted on the rotor. The fan may be of metal, or plastics material, or metal with plastics material moulded in situ on it, as described in the document FR 2 673 338. It may include all possible forms, from the simplest to the most complex. The fan may even include a cover plate, or a double stage of blades, in the manner described for example in the document FR 2 811 158. There is no restriction at all on the number of blades, or on the emplacement and size of these blades, that would be due to the balancing of the rotor and fan.

Very clearly the invention is not limited to an electrical machine having a claw-type motor, being for example an alternator of the Lundell type. The electrical machine such as an alternator may, while still being within the scope of the invention, be equipped for example with a rotor of the salient pole type, such as that described for example in the document WO02/054566. In that case, the balancing or pre-balancing of the rotor is made in the same way as for a claw-type motor, that is to say by forming holes in the axial ends of the rotor by means of drilling tools. Thus, thanks to the invention, balancing holes 25 formed in the rotor can be situated in line with fan blades, the rotor having been balanced before the pre-balanced fan is fitted on the rotor.

1. A rotary electrical machine comprising a stator (5) and a rotor (4), the rotor (4) including zones (26) which are adapted for balancing operations thereon, together with at least one fan (7, 9) which is adapted to be mounted on the rotor and which includes a radial plate portion (3) and fan blades (9a, 9b), characterised in that the fan fixed on the rotor is pre-balanced.

2. A rotary electrical machine according to claim 1, characterised in that the radial plate portion of the fan has a non-constant thickness.

3. A rotary electrical machine according to claim 2, characterised in that the radial plate portion of the fan includes portions of material of increased thickness and/or thinned zones.

4. A rotary electrical machine according to claim 3, characterised in that the radial plate portion of the fan includes holes.

5. A rotary electrical machine according to claim 1, characterised in that at least one blade includes additions of material (14a, 14b, 14c, 14d, 14e) for the purpose of balancing the fan.

6. A rotary electrical machine according to claim 1, characterised in that at least one blade has a chamfer (22) for the purpose of balancing the fan.

7. A rotary electrical machine according to claim 1, characterised in that the fan is a fan consisting of two superimposed fans (21, 22).

8. A rotary electrical machine according to claim 7, characterised in that at least one of the two fans includes added elements or thinned portions, or has material removed, with a view to balancing it.

9. A rotary electrical machine according to claim 8, characterised in that the radial plate portion of each of the two superimposed fans has holes or thinned portions in at least one common zone.

10. A rotary electrical machine according to claim 8, characterised in that the radial plate portion of each of the two superimposed fans includes holes or thinned portions in different zones.

11. A rotary electrical machine according to claim 1, characterised in that the rotor is pre-balanced.

12. A rotary electrical machine according to claim 11, characterised in that a balancing hole of the rotor is in line with a blade of the pre-balanced fan.

13. A rotary electrical machine according to claim 1, characterised in that the central bore (40) of the fan is de-centred so as to bring the axis of rotation of the machine into coincidence with the centre of gravity of the fan.

14. A rotary electrical machine according to claim 1, characterised in that the fan is fixed eccentrically on the rotor in order to bring the axis of rotation of the machine into coincidence with the centre of gravity of the fan.

15. A rotary electrical machine according to claim 1, characterised in that the rotor is a claw-type rotor (45).

16. A method of mounting a fan on a rotor of a rotary electrical machine, the rotor including zones reserved for pre-balancing purposes, characterised in that it includes operations of balancing the fan and then of fastening the balanced fan on the rotor.

17. A method according to claim 15, characterised in that the operation of balancing the fan consists in determining a centre of gravity of the fan in a three-dimensional Cartesian frame (XYZ), and forming thickened and/or thinned zones in the radial plate portion or on the blades of the fan, so as to bring the centre of gravity of the fan into coincidence with the axis of rotation (XX) of the rotary electrical machine.
